(19) United States
(12) Patent Application Publication
(10) Pub. No.: US 2007/0193656 A1
(43) Pub. Date: Aug. 23, 2007

(54) Method for manufacturing wooden floor

(76) Inventor: Chih-Kun Liao, Fongyuan City (TW)

Correspondence Address: SINORICA, LLC, 528 FALLSGROVE DRIVE, ROCKVILLE, MD, 20850, US

(21) Appl. No.: 11/501,769

(22) Filed: Aug. 10, 2006

(30) Foreign Application Priority Data
Jan. 26, 2006 (TW) 095201859

(51) Int. Cl. B27G 11/00; B27D 1/00

(52) U.S. Cl. 144/351

(57) ABSTRACT

A method for manufacturing wooden floor provides multiple first boards and multiple second boards that are arranged side by side and connected to one another by glue for forming a plank. The glue is applied to two opposite sides of each of the multiple first boards and multiple second boards. Each first board has a tenon longitudinally and centrally extending from one end thereof and each second board has a groove longitudinally and centrally defined in one end thereof for stably receiving the tenon of a corresponding one of the multiple first boards. The plank is divided into several thin plates for spreading on the ground after the glue is dried and, the multiple first boards and multiple second boards are stably connected to one another.

### BACKGROUND OF THE INVENTION

1. Field of the Invention

The present invention relates to a method, and more particularly to a method for manufacturing wooden floor that is stably assembled.

2. Description of Related Art

A conventional wooden floor in accordance with the prior art shown in FIGS. 5 and 6 comprises multiple first wooden boards (11) and multiple second wooden boards (12) connected to one another. The multiple first wooden boards (11) and the multiple second wooden boards (12) are arranged side by side and connected to one another by glue (20) for forming a plank (not numbered). The plank is horizontally divided into several thin plates for spreading on the ground. However, the first wooden board (11) and the second wooden board (12) are connected only by using glue (20) such that divided plank (think plate) may become warped due to the moist weather.

Another conventional wooden floor in accordance with the prior art shown in FIGS. 7 and 8 comprises multiple first wooden boards (11) and multiple second wooden boards (12) connected to one another. Each first wooden board (11) and second wooden board (12) has two opposite ends each having teethed structure (111/121) formed thereon. The multiple first wooden boards (11) and the multiple second wooden boards (12) are arranged side by side, the teethed structures (111, 121) are engaged to each other and connected to one another by glue (20) for forming a plank (not numbered). The plank is horizontally divided into several thin plates for spreading on the ground. The connection of the second conventional wooden floor is improved. However, the teethed structures (111, 121) may form a slant face after the plank being divided into think plates. The slant face between the first wooden board (11) and the second wooden board (12) may become warped due to the structure thereof.

The present invention has arisen to mitigate and/or obviate the disadvantages of the conventional wooden floors.

### SUMMARY OF THE INVENTION

The main objective of the present invention is to provide an improved method for manufacturing wooden floor that would not become warped.

To achieve the objective, the method in accordance with the present invention provides multiple first boards and multiple second boards that are arranged side by side and connected to one another by glue for forming a plank, the glue applied to two opposite sides of each of the multiple first boards and multiple second boards, each first board having a tenon longitudinally and centrally extending from one end thereof and each second board having a groove longitudinally and centrally defined in one end thereof for stably receiving the tenon of a corresponding one of the multiple first boards, the tenon and the groove being right angled the plank divided into several thin plates for spreading on the ground after the glue being dried and, the multiple first boards and multiple second boards are stably connected to one another.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a think plate that is made by a method in accordance with the present invention;

FIG. 2 is a perspective view of a plank that is made by a method in accordance with the present invention;

FIG. 3 is an exploded perspective view of the plank in FIG. 2;

FIG. 4 is a perspective view for showing the plank, in FIG. 1, horizontally divided into several think plates;

FIG. 5 is a perspective view of a first conventional assembled plank in accordance with the prior art;

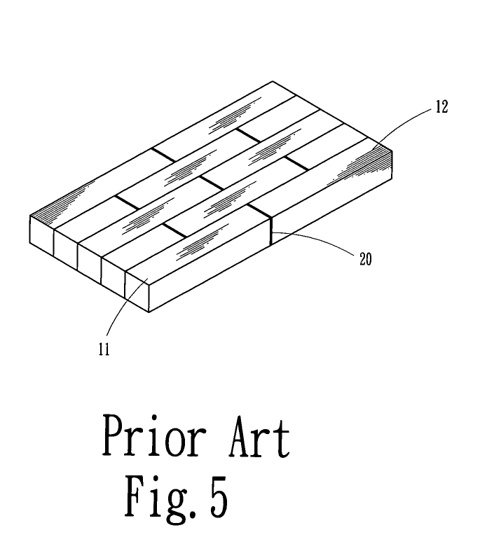

FIG. 6 is a perspective view for showing the plank, in FIG. 5, horizontally divided into several think plates;

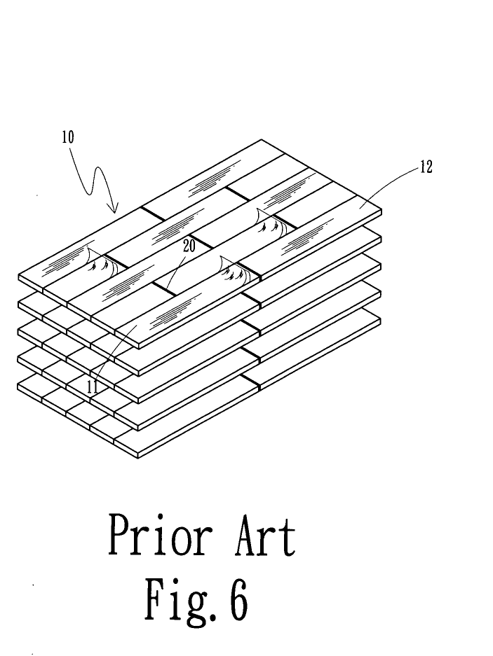

FIG. 7 is a perspective view of a second conventional assembled plank in accordance with the prior art; and

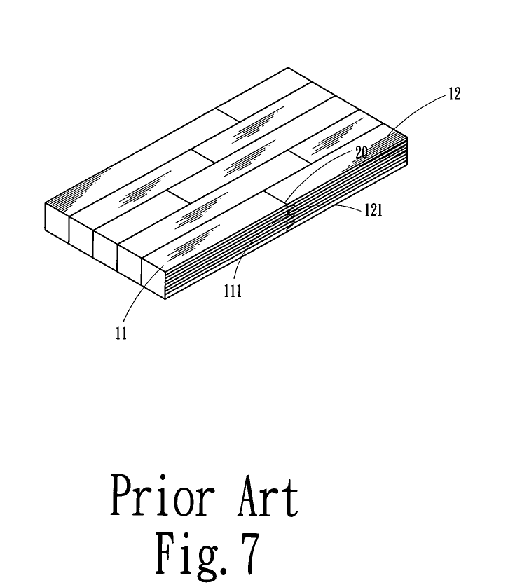

FIG. 8 is a perspective view for showing the plank, in FIG. 7, horizontally divided into several think plates.

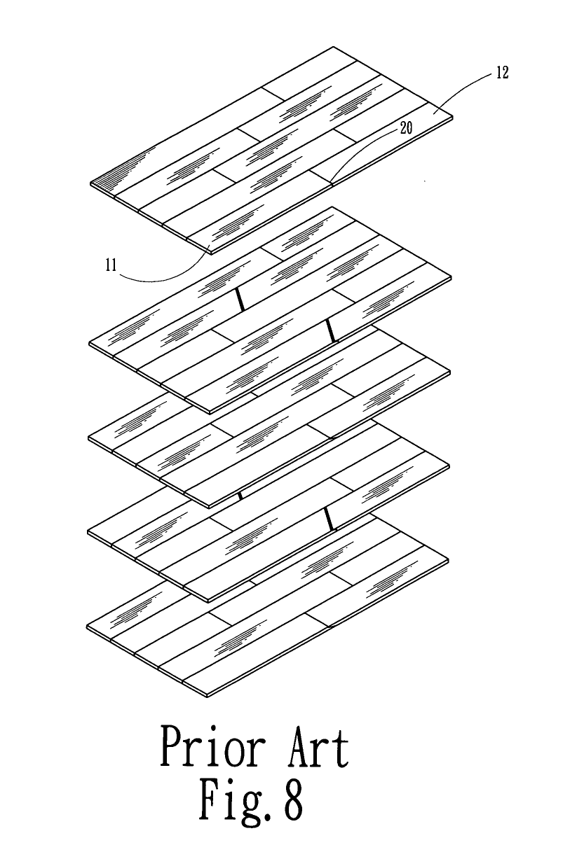

### DETAILED DESCRIPTION OF THE INVENTION

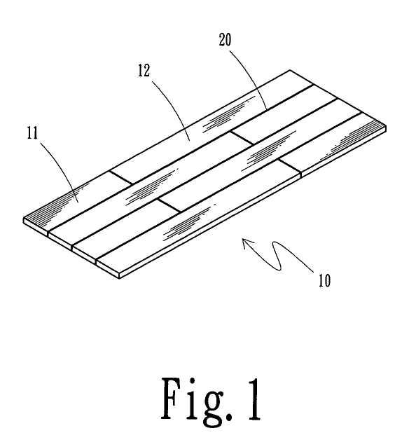

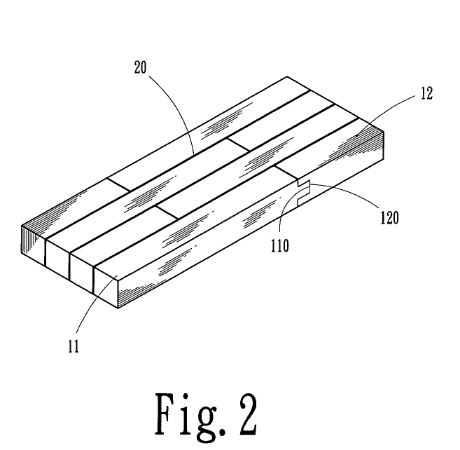

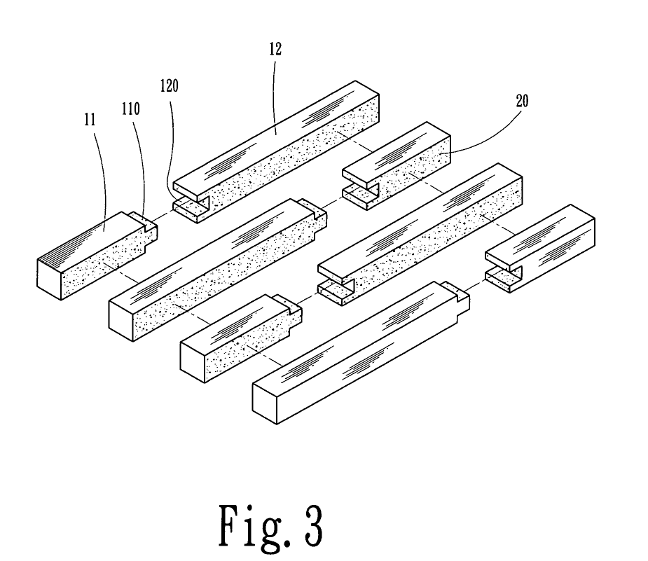

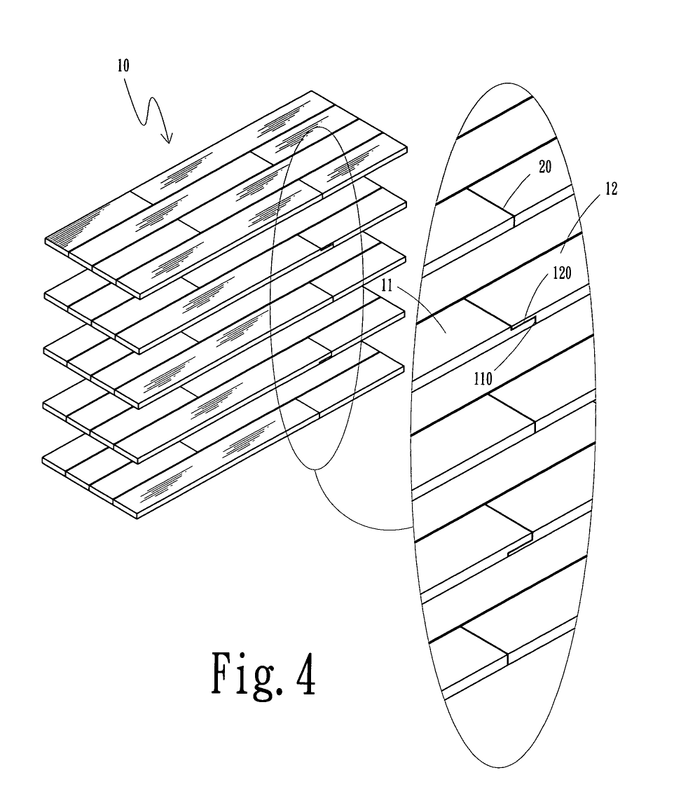

Referring to the drawings and initially to FIGS. 1-4, a method for manufacturing wooden floor in accordance with the present invention provides multiple first boards (11) and multiple second boards (12) that are arranged side by side and connected to one another by glue (20) for forming a plank. The glue (20) is applied to two opposite sides of each of the multiple first boards (11) and multiple second boards (12). Each first board (11) has a tenon (110) longitudinally and centrally extending from on end thereof and each second board (12) has a groove (120) longitudinally and centrally defined in one end thereof for stably receiving the tenon (110) of a corresponding one of the multiple first boards (11). The tenon (110) and the groove (120) are right angled. The plank is divided into several thin plates (10) for spreading on the ground after the glue (20) is dried and, the multiple first boards (11) and multiple second boards (12) are stably connected to one another.

As described above, the wooden floor made by the method in accordance with the present invention has several advantages as follow.

1. The multiple first boards (11) and multiple second boards (12) are stably connected to one another because the each first board (11) has a tenon (110) extending therefrom and each second board (12) defines a groove (120) for stably receiving the tenon (110).

2. There is no slant face formed between the divided first boards (11) and the second boards (12). The tenon (110) and the groove (120) are right angled such that the connecting line between the divided first boards (11) and the second boards (12) are parallel to each other, that is, the divided first boards (11)/the second boards (12) would not become warped.

Although the invention has been explained in relation to its preferred embodiment, it is to be understood that many other possible modifications and variations can be made without departing from the spirit and scope of the invention as hereinafter claimed.

What is claimed is:

1. A method for manufacturing wooden floor providing multiple first boards and multiple second boards that are arranged side by side and connected to one another by glue for forming a plank, the glue applied to two opposite sides of each of the multiple first boards and multiple second boards, each first board having a tenon longitudinally and centrally extending from one end thereof and each second board having a groove longitudinally and centrally defined in one end thereof for stably receiving the tenon of a corresponding one of the multiple first boards, the tenon and the groove being right angled the plank divided into several thin plates for spreading on the ground after the glue being dried and, the multiple first boards and multiple second boards are stably connected to one another.

2. The method for manufacturing wooden floor of claim 1 wherein length of each first board and length of each second board are different.
